(19) United States
(12) Patent Application Publication
(10) Pub. No.: US 2017/0073433 A1
(43) Pub. Date: Mar. 16, 2017

(54) Processes to Produce Unpurified Polygalacturonic Acids from Plant Tissue Using Calcium Sequestering Compounds

(71) Applicant: The United States of America, as Represented by the Secretary of Agriculture, Washington, DC (US)

(72) Inventor: Gary A. Luzio, Vero Beach, FL (US)

(21) Appl. No.: 14/850,162

(22) Filed: Sep. 10, 2015

(51) Int. Cl. C08B 37/00; C09K 8/68; C09K 8/90; C09K 8/08

(52) U.S. Cl. CPC C08B 37/0048; C09K 8/08; C09K 8/68; C09K 8/90

(57) ABSTRACT

Described herein are processes to produce polygalacturonic acids from pectin containing products, said process involving
(a) optionally washing pectin containing products,
(b) optionally injecting dry steam into pectin containing products [and maintaining a temperature of about 140° to about 160° C. under pressure at about 40 to about 60 psi for a time period of between about 0.5 to about 3 minutes,
(c) optionally heating pectin containing products to above about 70° C. to about 95° C. or optionally cooling to less than about 10° C.,
(d) adding to said pectin containing products at least one calcium sequestering salt in an amount sufficient to provide a mixture having a pH of equal to or greater than about 8 and a total molarity of phosphate greater than a total molarity of Ca⁺⁺ indigenous to said pectin containing products,
(e) optionally cooling or heating after adding said at least one calcium sequestering salt,
(f) storing the mixture of pectin containing products and at least one calcium sequestering salt for about 24 hours or less,
(g) heating said mixture for about 15 min to about 4 hours at about 40° to about 95° C.,
(h) optionally adjusting the pH of said mixture to about 7 to about 8 by adding acid to said mixture,
(i) optionally drying said mixture which contains polygalacturonic acids, and
(j) optionally milling or grinding said mixture.

Also described herein are polygalacturonic acids produced by the above process and gels containing the polygalacturonic acids (produced by the above process) and water.

### BACKGROUND OF THE INVENTION

Described herein are processes to produce polygalacturonic acids from pectin containing products, said process involving
(a) optionally washing pectin containing products,
(b) optionally injecting dry steam into pectin containing products [and maintaining a temperature of about 140° to about 160° C. under pressure at about 40 to about 60 psi for a time period of between about 0.5 to about 3 minutes,
(c) optionally heating pectin containing products to above about 70° C. to about 95° C. or optionally cooling to less than about 10° C.,
(d) adding to said pectin containing products at least one calcium sequestering salt in an amount sufficient to provide a mixture having a pH of equal to or greater than about 8 and a total molarity of phosphate greater than a total molarity of Ca⁺⁺ indigenous to said pectin containing products,
(e) optionally cooling or heating after adding said at least one calcium sequestering salt,
(f) storing the mixture of pectin containing products and at least one calcium sequestering salt for about 24 hours or less,
(g) heating said mixture for about 15 min to about 4 hours at about 40° to about 95° C., (h) optionally adjusting the pH of said mixture to about 7 to about 8 by adding acid to said mixture,
(i) optionally drying said mixture which contains polygalacturonic acids, and
(j) optionally milling or grinding said mixture.

Also described herein are polygalacturonic acids produced by the above process and gels containing the polygalacturonic acids (produced by the above process) and water.

The problem encountered with suspension mixtures containing insoluble components is the tendency of the insoluble components to separate (e.g., via sedimentation or creaming). In order to maintain insoluble components in suspension, such as with drilling or fracking fluids and other industrial fluids, polysaccharide gums such as guar gum are added. Guar gum and other viscosifying gums such as carboxymethyl cellulose are expensive and are susceptible to hydrolysis under many harsh industrial conditions. In addition, these gums may require the use of heavy metal ions such as borate for crosslinking and viscosity build for these applications. Use of heavy metals for these suspension aids creates environmental hazards and disposal problems. Thus there exists a need for low cost environmentally friendly suspension aids, especially those that can be made from agricultural processing wastes (e.g., pectin), for industrial applications such as those encountered in the drilling industry. There also exists a need for a polysaccharide suspension aid which exhibits improved stability under harsh chemical environments. Other applications that require low-cost and harsh-pH stable polysaccharides include applications such as ion-capture, encapsulation, and controlling water retention properties.

The control of soluble calcium ion throughout a pectate producing process is critical to maximize solubility of pectate in the final product. The ability to sequester calcium ion greatly facilitates the need for rehydration of dried plant materials that are used to produce pectates. Control of the solubility of calcium is needed to maximize the utilization of calcium pectate gels or low molecular weight pectates needed for a wide variety of applications such as ion-capture (Cameron, R. G., et al., Proc. Fla. State Hort. Soc., 121: 311-314 (2009), encapsulation (Bigucci, F., et al., J. Pharmacy and Pharmacology, 61(1): 41-46 (2009); Nutithawat, T., et al., Spray-Dried Pectic Polysaccharide Powders: Evaluation of Physicochemical Properties for Pharmaceutical Preparations, Advanced Materials Research, 93-94, 417-420 (2010), controlling water retention properties (Willats, W. G., et al., J. Biol. Chem., 276(22): 19404-19413 (2001), or rheology/texture modification in foods (Sila, D. N., et al., Comp. Rev. Food Sci. Safety, 8(2): 86-104 (2009)). Calcium can be controlled by its removal with acid washes before drying, but this is expensive, difficult to do, and is not economical for many low cost industrial applications. To date there has been no economical and simplified processes for controlled sequestering or release of calcium ion.

The use of polygalacturonic acid, also known as pectate, for suspension and drilling mud applications was described in U.S. Pat. No. 2,319,705. The quantitative superiority of the pectate containing drilling mud over conventional drilling muds was shown. The crude pectate pulp preferred was a material ordinarily obtained by processing plant tissue such as the pulp obtained from pressing fruits and vegetables. Pectins are closely associated with the cellulose and hemicelluloses of the cell wall of most fruits and vegetables (e.g., apples, pears, lemons, oranges, rhubarb, carrots, beets, etc.; Atmodjo, M. A., et al., Annual Review of Plant Biology, 64(1): 747-779 (2013)). Careful treatment of such plant tissue is described but there is no incorporation of a process step to sequester calcium ions present in the plant tissue during extraction.

U.S. Pat. No. 2,666,032 used alkaline extraction to produce oligogalacturonic acids (low molecular weight polygalacturonic acids or low molecular weight pectates) with alkaline extraction at high temperature. Again there is no description of how to sequester calcium ion, a polyvalent metal ion, in the process and this patent aims at producing low molecular weight polygalacturonic acids by using high heat in the alkaline treatment. The patent describes soluble oligogalacturonic acids with calcium present, but it has been shown that oligogalacturonic acids with degrees of polymerization greater than 7 can become insoluble in the presence of polyvalent metal ions (Kohn, R., et al., Collect Czech Chem Commun, 48: 1922-1935 (1983)). For many suspension applications, high molecular weight is essential for providing necessary gel structure or viscosity which requires low temperature treatment but this patent does not address that requirement. Similar alkaline extraction (but not in situ isolation of calcium ion) is described in U.S. Pat. No. 7,833,558.

U.S. Pat. No. 4,065,614 uses amidation to control lack of solubility of pectates in the presence of calcium ion via the production of pectin amides. In this field, the starting pectin is any of the commercially available high-ester pectins such as citrus pectin, apple pectin and the like, and a degree of esterification over 60% is essential and indeed over 65% is preferred. Low-ester purified pectins (non-amidated pectins), when evaluated in varied pH gels having about 30% soluble solids, showed a steady decline in gel strength as the pH was increased from pH 3.5 and above. In addition, low ester pectins undergo syneresis in the presence of calcium ions (Morris, E. R., et al., J. Molecular Biology, 138(2): 363-374 (1980)). The patent describes that low ester amidated pectins solve these problems; however, production of these amidated pectins is not cost effective since they are highly purified forms of pectins and the amide groups of these pectins would hydrolyze under alkaline conditions which are encountered in many industrial applications. The high cost renders these products unsuitable for many low cost applications.

U.S. Pat. No. 4,629,575 discloses that parenchymal cell-derived cellulose (PCC) has been found to be unique among native cellulose isolates in that it forms viscous, gravitationally stable suspensions at low solids content. In the concentration range of 0.5 to 3.0% w/w, PCC forms a gel-like, aqueous suspension which displays pseudoplasticity. This behavior can be approximated by the Bingham plastic model used to describe highly flocculated clays. Pectin and polygalacturonic acid are described as important components of such hemicelluloses which may be present in the starting materials or used as additives with the parenchymal cell-derived cellulose. An alkaline saponified preparation of the hemicellulose complex isolated from sugar beet pulp was described, but there is no description of how to sequester calcium ions during the process. Calcium is a polyvalent metal ion which must be isolated to fully functionalize the pectins when they are deesterified to polygalacturonic acid via alkaline treatment. Removal of calcium is essential to fully solubilize the polygalacturonic acid before producing psuedoplastic gels for particulate suspensions.

WO 91/15517 describes 5-45% by weight of pectic substances calculated as galacturonic acid and having a degree of esterification in the range of 45-90%. This degree of esterification is unsuitable for many applications where alkaline conditions are encountered, and the pectin would undergo hydrolysis via beta elimination reactions at pH values greater than 6.1, especially if divalent cations are present (Keijbets, M. J. H., and W Pilnik, Carbohydrate Research, 33(2): 359-362 (1974)). It is also unsuitable for any conditions where cross linking with divalent cations would be required since alkaline saponification as described therein results in a random deesterification process which would provide minimal cross linking with divalent cations (Morris, E. R., et al., (1980)). What is needed for applications wherein the pH is greater than 6.0 is a degree of esterification of less than 20 percent, and preferably lower, for maximum stability with regards to hydrolysis of the polymers glycosidic linkages (Albersheim, P., Biochemical and Biophysical Research Communications, 1(5): 253-256 (1959); Fraeye, I., et al., Food Chem., 105(2): 555-563 (2007); Fraeye, I., et al., Innov. Food Sci. Emerg., 8(1): 93-101 (2007) and the introduction of deesterified blocks large enough to allow divalent cation cross linking (Kohn, R., and O. Luknar, Collection of Czechoslovak Chemical Commununications, 42: 731-744 (1977); Luzio, G. A., and R. G. Cameron, Carbohyd. Poly., 71: 300-309 (2008)).

U.S. Pat. No. 6,348,436 described the following steps for treating beet root pulp: (a) first acidic or basic extraction, after which a first solid residue is recovered, (b) optionally a second extraction, carried out under alkaline conditions, of the first solid residue after which a second solid residue is recovered, and (c) washing of the first or second solid residue. This approach can solubilize the pectin via acid extraction in step (a) but pectin will be lost in step (c) upon washing. If only alkaline extraction is used in step (a) then again the reference does not teach how to control indigenous calcium which prevents the complete solubilization of the pectin necessary for use in the final product.

Some patents do teach the need of isolating the calcium ion during extraction of pectin. For example, U.S. Pat. No. 8,592,575 teaches the importance of sequestering calcium ion from pectin (which other patents do not take into consideration) during extraction via addition of oxalic acid under acidic conditions which preserves the ester content. However, this process is not cost effective for production of polygalacturonic acid which is needed for cost sensitive applications and the production is for a high ester pectin (ester content approximately 70%) which is unstable for many applications where pH values greater than 6.1 are encountered and where a need for divalent cation cross linking is required.

Commercially available pectins have also been described to be useful for many applications for suspensions as noted in U.S. Pat. No. 8,592,575. Examples of commercially available pectinates suitable for use in this disclosure include GENU® X-914 (low methylation) and GENU® PECTIN (Citrus) USP/100 (high methylation), each of which is available from CP Kelco, Inc. These pectins are made via conventional acid extractions and are not suitable for cost sensitive applications such as those involving well boring, proppant delivery in horizontal fracturing applications, or well drilling clean out operations Nevertheless, the need was noted for such materials for servicing a wellbore in contact with a subterranean formation involving placing a wellbore servicing fluid containing a polyuronide polymer within the wellbore, contacting the wellbore servicing fluid with a divalent ion source, and allowing the wellbore servicing fluid to form a gel within the wellbore wherein the divalent ion source is located within the wellbore.

Described herein are novel products which provide low-cost and harsh-pH stable polysaccharides with controlled calcium release for applications involving, for example, suspension, ion-capture, encapsulation, and controlling water retention. Suspension applications include drilling muds or fracturing/completion fluids for proppant delivery and well drilling cleanout operations. These novel materials can be used in harsh subterranean conditions of high heat and low pH or high pH where other known polysaccharide based suspension aids would be hydrolyzed and would fail. These novel materials also provide a higher value alternative to citrus peel use than is currently available since peel is typically sold as cattle feed with little or no profit margins. Adding profit to citrus juicing and eliminating waste peel would have a major impact on the citrus juicing industry.

### SUMMARY OF THE INVENTION

Described herein are processes to produce polygalacturonic acids from pectin containing products, said process involving
(a) optionally washing pectin containing products,
(b) optionally injecting dry steam into pectin containing products [and maintaining a temperature of about 140° to about 160° C. under pressure at about 40 to about 60 psi for a time period of between about 0.5 to about 3 minutes,
(c) optionally heating pectin containing products to above about 70° C. to about 95° C. or optionally cooling to less than about 10° C.,
(d) adding to said pectin containing products at least one calcium sequestering salt in an amount sufficient to provide a mixture having a pH of equal to or greater than about 8 and a total molarity of phosphate greater than a total molarity of Ca⁺⁺ indigenous to said pectin containing products,
(e) optionally cooling or heating after adding said at least one calcium sequestering salt,
(f) storing the mixture of pectin containing products and at least one calcium sequestering salt for about 24 hours or less,
(g) heating said mixture for about 15 min to about 4 hours at about 40° to about 95° C.,
(h) optionally adjusting the pH of said mixture to about 7 to about 8 by adding acid to said mixture,
(i) optionally drying said mixture which contains polygalacturonic acids, and
(j) optionally milling or grinding said mixture.

Also described herein are polygalacturonic acids produced by the above process and gels containing the polygalacturonic acids (produced by the above process) and water.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

FIG. 1 shows viscosity for various trisodium phosphate (TSP) treatments for oven dried, milled peel at 20 reciprocal seconds and 25° C. as described below.

FIG. 2 shows viscosity determination for the same samples as in FIG. 1 run 24 h later as described below.

FIG. 3 shows viscosity at 172 reciprocal seconds and 25° C. for oven dried, milled and TSP treated peel (treatment B) as described below.

FIGS. 4A and 4B show rheological properties for oven dried, milled TSP treated peel (treatment B) as described below: (A) G′ and G″ at 170 reciprocal seconds and 65° C.; (B) Viscosity at 170 reciprocal seconds and 65° C.

FIGS. 5A and 5B show viscosity for steam exploded, TSP treated peel (treatment B) determined at 170 reciprocal seconds and 65° C. as described below: (A) 1.5% peel, (B) 3.0% peel.

FIG. 6 shows viscosity for steam exploded, TSP treated peel (treatment B) determined at 170 reciprocal seconds and 65° C. for 1.5% peel as described below; peel was from a different source and steam treatment run from the peel in FIG. 5.

FIG. 7 shows G′ and G″ for TSP treated (treatment B), oven dried milled peel from 65° to 90° C. at 6.283 rads/s with and without Ca as described below: (A) Temperature Sweep, (B) Temperature Ramp.

### DETAILED DESCRIPTION OF THE INVENTION

Described herein are processes to produce polygalacturonic acids from pectin containing products, said process involving
(a) optionally washing pectin containing products,
(b) optionally injecting dry steam into pectin containing products [and maintaining a temperature of about 140° to about 160° C. under pressure at about 40 to about 60 psi for a time period of between about 0.5 to about 3 minutes,
(c) optionally heating pectin containing products to above about 70° C. to about 95° C. or optionally cooling to less than about 10° C.,
(d) adding to said pectin containing products at least one calcium sequestering salt in an amount sufficient to provide a mixture having a pH of equal to or greater than about 8 and a total molarity of phosphate greater than a total molarity of Ca⁺⁺ indigenous to said pectin containing products,
(e) optionally cooling or heating after adding said at least one calcium sequestering salt,
(f) storing the mixture of pectin containing products and at least one calcium sequestering salt for about 24 hours or less,
(g) heating said mixture for about 15 min to about 4 hours at about 40° to about 95° C., (h) optionally adjusting the pH of said mixture to about 7 to about 8 by adding acid to said mixture,
(i) optionally drying said mixture which contains polygalacturonic acids, and
(j) optionally milling or grinding said mixture.

Also described herein are polygalacturonic acids produced by the above process and gels containing the polygalacturonic acids (produced by the above process) and water.

Disclosed herein are unpurified forms of polygalacturonic acid (pectates) which can be used in aqueous solutions to form weak gels and processes for producing the same from a pectin containing starting material. These gels exhibit substantially no phase separation in an aqueous solution and thus can maintain suspension properties. Gels are formed via controlled release of calcium ion following acidification or by the addition of excess cations from salts (e.g., calcium chloride) to provide crosslinking between carboxyl groups. In particular, disclosed are unpurified forms of polygalacturonic acid prepared by deesterifying crude high methoxyl pectin with reagents (herein described as calcium sequestering salts) that interact with calcium ions to form salts that have very low solubility product constants (Kₛₚ) (e.g., 1.0×10⁻²⁰ M to 1.0×100⁻²⁰⁰ M at 37° C.). Kₛₚ is the equilibrium constant for a solid substance dissolving in an aqueous solution and it represents the level at which a solute dissolves in solution. The less a substance dissolves, the lower is the Kₛₚ value. Under acidic conditions, for example pH less than about 6.2 to about 3.8 (e.g., less than 6.2 to 3.8), these calcium sequestering salts have an increase in their Kₛₚ value such that they release a limited amount of calcium into solution. These free calcium ions can then react with an unpurified polygalacturonic acid contained in the same matrix to form shear thinning gels in situ. Also described are stabilized aqueous systems containing impure mixtures of polygalacturonic acid prepared from compounds that sequester calcium ions during production.

Pectin starting material is intended to mean a pectin product not wholly separated from plant material. The pectin starting material can preferably be obtained from citrus peels, apple juices, apple ciders, apple pomade, sugar beets, sunflower heads, mango peels, avocado peels, vegetables or waste products from plants such as apples, sugar beet, sunflower and citrus fruits, more preferably apples, sugar beets and citrus plants, and most preferably citrus plants such as limes, lemons, grapefruits, and oranges. The pectin starting material can be the pulp and peel left over after juicing the citrus, preferably before the addition of lime such as calcium oxide, less preferable after the addition of lime before drying, or after the addition of lime and drying, or after the addition of lime, drying and then pelletizing. Existing plant equipment used for animal feed production may be used to produce unpurified form of polygalacturonic acid which saves on capitol costs.

Described herein are methods for extraction of pectin having a low degree of esterification (for example, preferably less than about 50% (e.g., less than 50%), more preferably less than 20% (e.g., less than 20%), preferably 0% to about 10% (e.g., 0% to 10%), and most preferably less than 10% (e.g., less than 10%)) esterified pectins (also known as pectates) from pectin-containing plant materials using calcium sequestering salts (e.g., phosphates) for simultaneous extraction and deesterification. Generally, processes for extracting pectates having a degree of polymerization which depends on the application are described. For applications involving suspensions, the degree of polymerization is generally >than about 20 (e.g., greater than 20), preferably >than about 150 (e.g., greater than 150), more preferably >than 300 (e.g., greater than 300), and most preferably >than 600 (e.g., greater than 600) galacturonic acid units on average. For applications involving low viscosity needs, the preferred degree of esterification is opposite that of suspensions such that the degree of esterification is preferred to be <about 600 (e.g., less than 600), more preferably <200 (e.g., less than 200), more preferably one to about 20 (e.g., one to 20), and most preferably <about 20 (e.g., less than 20) galacturonic acid units on average. The process is generally a single-stage extraction that involves preparing a blend of pectin-containing plant materials (which have, or have not, been water washed) together with calcium sequestering salts (e.g., phosphate compounds such as trisodium phosphate, tripotassium phosphate, or triammonium phosphate) in an amount sufficient to provide a mixture having a pH of equal to or greater than about 8 (e.g., equal to or greater than 8) and a total molarity of phosphate greater than the total molarity of Ca⁺⁺ indigenous to the pectin-containing plant materials (e.g., peel); the preferred range of pH is from about 8 to about 14 (e.g., 8 to 14), more preferably from about 8 to about 12 (e.g., 8 to 12), and most preferably from about 9 to about 11 (e.g., 9 to 11). The separate ingredients may be cooled to less than about 10° C., but generally above 0° C. to avoid freezing, prior to mixing to make the blend; cooling before mixing is done to maximize molecular size of the pectates. Following cooling and then blending the mixture is stored for a sufficient time to reduce ester content of 0% to about 20% (e.g., 0 to 20%), preferably below about 20% (e.g., below 20%); preferred time of storage is less than about 24 hours (e.g., less than 24 hours), more preferably less than about 12 hours (e.g., less than 12 hours), more preferably about 2 to about 8 hours (e.g., 2 to 8 hours), and most preferably less than about 8 hours (e.g., less than 8 hours, with lower limit of about 1 hour with addition of excess phosphate. Subsequent heating (after deesterification which occurs after the storage step above) of the mixture to a temperature from about 40° to about 95° C. (e.g., 40° to 95° C.), more preferably from about 60° to about 90° C. (e.g., 60° to 90° C.), and most preferably from about 75° to about 85° C. (e.g., 75° to 85° C.), is done from about 15 minutes to about 4 hours (e.g., 15 minutes to 4 hours), preferably from about 15 minutes to 2 hours (e.g., 15 minutes to 2 hours), more preferably from about 15 to about 60 minutes (e.g., 15 to 60 minutes), and most preferably from about 15 to about 30 minutes (e.g., 15 to 30 minutes) to form insoluble calcium phosphates and to extract pectates formed in-situ from the pectin-containing plant material. Separation of the unbound pectates from other materials present in the mixture is not required (and is generally not done) prior to drying which saves on processing cost and aids in product stability; pectates are extracted (no longer covalently bound) but are not separated from the mixture, they remain part of the mixture. Neutralization of the blend, by addition of acid (e.g., nitric acid, phosphoric acid, hydrochloric acid), prior to drying to a pH between the values of about 7 to about 8 (e.g., 7 to 8) is optional to lower the alkalinity of the blend. The unbound pectate preferably has a degree of esterification (DE) of less than about 10% (e.g., less than 10%) and a high degree of polymerization (for high gel strength applications); the degree of polymerization being characterized by a molecular size of greater than about 17,500 Daltons (e.g., greater than 17,500 Daltons), preferably greater than about 30,000 (e.g., greater than 30,000 Daltons), more preferably >about 70,000 Daltons (e.g., greater than 70,000 Daltons), and most preferably >about 120,000 Daltons (e.g., greater than 120,000 Daltons) on average which is the typical upper limit for unaggregated pectins which are extracted from citrus peel, but may be higher if other plant tissue sources are utilized.

Release of calcium and subsequent ionic cross linking of the pectate product formed as described in the previous paragraph at the application site (e.g., drilling site) can be achieved first by hydration followed by addition of acid sufficient to lower the pH, generally to about 6 or below (e.g., to 6 or below 6; the lower the pH the faster the solubilization, thus a lower limit could be less than pH 2 but going to such lower pH values would work but would be impractical) The addition of acid at this step enhances water solubility of calcium phosphates present in the mixture which releases sufficient calcium in a uniform manner to form calcium crosslinks between the pectate molecules, thus forming the gel. An alternate process (for applications wherein the pH is greater than 6.1) is to leave the hydrated pectate as an alkaline mixture and add a quantity of calcium ion (e.g., calcium chloride, calcium nitrate, calcium sulfate) to produce a total molarity of calcium in excess of the molarity of the free phosphate ion present in the mixture; the quantity of additional calcium will be dependent on the source of pectin and on the initial amount of sodium phosphate added to the peel and also the amount of calcium present in the peel during the reaction. This would be useful for applications (e.g., some drilling applications) where alkaline conditions are encountered in the final application and release of calcium is restricted. Thus it would not be feasible to lower the pH below about 6 in these particular alkaline applications. This step is not limited to the addition of Ca⁺⁺ to achieve crosslinking and gelation, addition of other polyvalent cations (described herein) in excess of the molar equivalent of phosphate not bound with calcium could also be used in both acid and alkaline pH values. Other cations which may be useful include but are not limited to polyvalent cations such as aluminum, copper, barium, iron, etc. Separately, monovalent cations can induce gelation of pectates and these include, for example, sodium, potassium and rubidium.

Chemically, pectin is a complex polysaccharide composed of three recognized domains. The dominant domain is the homogalacturonan acid region (HG). It is a straight chain of α-D-galacturonic acid (GalA) molecules linked by α1,4 glycosidic linkages which are all di-equatorial due to the Cl conformation, and these carboxyl groups are mostly esterified in the native state in plant tissue. The structure of single unesterified D-galacturonic acid unit is shown below:

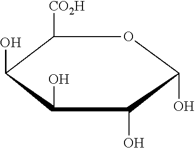

Other domains are the rhamnogalacturonan I (RG I) and rhamnogalacturonan II (RG II) regions. The linear backbone of RG I is composed of alternating GalA and rhamnose dimers. This backbone is decorated with short polymers of galactose (galactans) and arabinose (arabinans) and arabino-galactans attached to the rhamnose moiety (McNeil, M., et al., Plant Physiol., 66(6): 1128-1134 (1980); O'Neill, M. A., et al., Annual Review of Plant Biology, 55(1): 109-139 (2004); O'Neill, M. A., et al., J. Biol. Chem., 271(37): 22923-22930 (1996)). Pectin is not a pure component of plant tissue, but typically is found together with cellulose and hemicellulose in the cell walls of plants (Talmadge, K. W., et al., Plant Physiol., 51(1): 158-173 (1973)). The carboxylate groups in plant pectins are present predominantly as methyl esters with varying degrees of methylation. Herein a high degree of methylation refers to from about 50% to about 80% (e.g., 50 to 80%) of the C⁶—COOH present as the methyl ester, while a low degree of methylation refers to methylation of less than about 50% (e.g., less than 50%) of the carboxylic acid groups present. Pectins with a degree of methylation of less than about 15% (e.g., less than 15%) are herein referred to as pectates. High pH conditions (e.g., pH>8) are used herein to deesterify the pectins to form pectates. Non-methylated carboxylic acid groups on the pectates may be present as free —COOH acids, or as sodium, potassium, calcium or ammonium salts. The preferred form is either as the —COOH or in association with monovalent cations such as sodium ions or ammonium ions. Association with indigenous Ca⁺⁺ must be avoided during the process of deesterification to maximize the solubility of the pectates. A pectate suitable for final end use (e.g., drilling fluid applications) has a degree of methylation of from 0% to about 20% (e.g., 0 to 20%), preferably from 0% to about 10% (e.g., 0 to 10%). The average degree of polymerization is typically determined by the end use. Degree of polymerization is the number of galacturonic acid units in a given pectate molecule. In some instances degrees of polymerization of less than 30 are preferred for low viscosity applications (e.g., chelation of metals from mining wastes). For many suspension applications, higher degrees of polymerization (e.g., greater than 500) are preferred. Degree of polymerization is controlled by the initial temperature and alkaline pH value during addition of calcium sequestering salts as follows and thus lower initial temperatures are preferred before addition of alkali. The separate ingredients may be cooled to less than about 10° C., but generally above 0° C. to avoid freezing before addition of alkali.

The following are the general steps used in the process (citrus peel is described only as an example): (1) peel washing (e.g., counter current triple stage, screw pressing between stages; generally cooling is not involved prior to or during washing since the idea of the washing is to remove soluble impurities and cooling before or during washing would lower the amount of soluble solids that would be removed, furthermore heating prior to washing is generally not conducted since the peel is somewhat acidic so heating would result in loss of some of the pectin in the wash; (2) optionally peel conditioning (e.g., cooling to less than about 10° C. (e.g., less than 10° C. to a lower limit of about 2° C. (e.g., 2° C.)) to preserve molecular size for maximum viscosity applications or heating to greater than about 70° C. (e.g., greater than 70° C. to an upper limit of about 95° C. (e.g., 95° C.)) to reduce molecular size for applications requiring low viscosity pectates; (3) treatment of peel with calcium sequestering salt; (4) heating from about 40° C. to about 95° C. (e.g., 40° to 95° C.) for up to about 4 hours (e.g., up to 4 hours); (4) drying (e.g., drum drying) and dry milling (optional); (5) eluate from step 1 may be fermented for ethanol production.

Peel washing (optional but preferred): plant tissue, such as citrus peel, may need to be washed to remove soluble sugars and salts. For example, citrus peel washing can be done via a process similar to that for citrus pectin peel preparation which is somewhat different than drying citrus peel for animal feed production which does not require peel washing. The purpose of the peel washing step also includes removing soluble sugars for use in ethanol production as described in U.S. Pat. No. 8,372,614. The washing also removes low molecular weight saccharides that could promote product spoilage and which do not contribute to the rheological properties of the final product. Washing does not remove calcium ions which remains tightly bound to the plant tissue. Calcium ions must be isolated during deesterification to maximize solubility of the deesterified pectins. The washing step of the process is well known to those skilled in the art, for example the washing step described by Vincent Corporation http://www.vincentcorp.com/content/citrus-pectin-peel-preparation.

Peel conditioning: Washed peels are cooled (e.g., about 4° to less than about 10° C. (e.g., 4° to less than 10° C.)) or optionally heated (e.g., greater than about 70° to about 95° C., e.g., 70° to 95° C.). Peel cooling to lower temperatures (e.g., less than about 10° C.) before the addition of calcium sequestering salt is necessary to preserve molecular weight and maximize suspension properties. This can be done, for example, with inline cooling feed from the peel washing stage or 2 stage vacuum cooling (and then stirred, jacketed tank). This step is done to minimize β elimination reactions (Albersheim, 1959). Loss of functional properties of pectins at high pHs (e.g. >pH 5.5) has been recognized for more than 50 years (Kertesz, 1951). In pH conditions greater than 5.5, pectins are degraded by two competitive reactions: β-elimination, which create double bonds next to a methoxylated galacturonic moiety, and demethylation by saponification (Neukom, H., and H. Deuel, Chemistry and Industry, p. 683 (1958); Albersheim et al., Arch. Biochem. Biophys., 90: 46-51 (1960)). This competition is modulated by pH and temperature conditions: any increase of temperature increases the rate of β-elimination more than that of demethylation, while an increase of pH increases demethylation more than β-elimination (Kravtchenko et al., Carbohydr. Polymr. 20 (3): 195-206 (1992)). Heating at neutral to slightly acidic pHs (e.g., pH about 7 to about 4.5 (e.g., 7 to 4.5) (Albersheim, Biochem. Biophys. Res. Comm., 1 (5): 253-256 (1959); Kravtchenko et al., Carbohydr. Polymr. 20 (3): 195-206 (1992)) leads to extensive depolymerisation of pectins via β elimination and should be avoided to maintain molecular weight of pectin. If maintenance of molecular weight is not needed then the initial peel cooling step can be eliminated. The relative rates of the two competing reactions have been determined (Renard and Thibault, Carbohyd Res., 286: 139-50 (1996); Fraeye, I., et al., Innov. Food Sci. Emerg., 8(1): 93-101 (2007)) and these kinetic rates can be used to guide process conditions for this embodiment to obtain pectates of a particular molecular size range. In a separate optional embodiment, for lower molecular weight (e.g. <10,000 daltons) with degrees of polymerization less than 50, 0 elimination is induced by avoiding the cooling and instead heating the plant tissue to greater than about 70° to about 95° C. (e.g., 70° to 95° C.) before addition of the Ca sequestering salt (e.g., phosphate salt). The sequestering salt may be added in batch-wise to maintain the pH less than about 10 (e.g., less than pH 10 to 7), again to maximize β elimination reaction over deesterification reaction.

Treatment of peel with calcium sequestering salt: This step is uncomplicated in application but complex relative to the chemistry involved in the process. The step involves mechanical blending of peel (optionally chilled or heated) with calcium sequestering salts (e.g., trisodium phosphate or other phosphate salts such as triammonium phosphate, tripotassium phosphate, or salts of organo phosphate esters where organo is composed of alkyl, vinylic, aryl, and acyl hydrocarbons) and placement in a holding tank. The mixture is held in a chilled (or heated) state until the degree of methylation of the pectin is less than about 20% (e.g., less than 20%), preferably less than about 10% (e.g., less than 10% down to 0%). If a particular range of molecular weight is not needed then chilling or heating can be eliminated as noted previously. Following substantial deesterification (e.g., reduction in degree of esterification to less than 20 percent), the mixture is preferably heated (to drive the equilibrium toward removal of calcium from pectates to form insoluble phosphates but it could be optional, if there is no heating then the pectates would not be fully solubilized and the final product would not work as well in the final application as compared to a product formed by inclusion of this heating step) to a temperature from about 40° to about 95° C. (e.g., 75° to 85° C.) for a minimum of about 30 minutes (e.g., minimum of 30 minutes) up to about 4 hours (e.g., up to 4 hours) to maximize formation of insoluble calcium phosphates and to maximize extraction of pectates formed in-situ from the pectin-containing plant material.

It is essential that sequestration and isolation of Ca⁺⁺ ions (indigenous in plant tissue such as citrus peel) as calcium phosphates be accomplished at this stage by adding a Ca sequestering salt. The sequestration of Ca⁺⁺ ions is done to enhance the necessary solubility of impure pectins during deesterification under high pH conditions to form pectates free of bound calcium ion. This step of the process for extracting pectates having a high degree of polymerization in a single-stage extraction involves preparing a blend of water-washed pectin-containing plant materials together with calcium sequestering salts in an amount sufficient to provide a mixture having a pH of greater than about 8 (e.g., greater than pH 8 to pH 14) and a total molarity of phosphate greater than a total molarity of Ca⁺⁺. This unique process results in combination of highly soluble pectates and insoluble calcium phosphate compounds which will remain in that state until final treatment with acid at the application site to initiate release of calcium ion. Final treatment at the application site allows for subsequent pectate solvation prior to controlled reaction of calcium in a final application by lowering pH or adding additional calcium ions. This sequestration of Ca⁺⁺ ions is essential since the binding of Ca⁺⁺ ions to pectates is very strong and is dependent on the degree of polymerization (DM) of the pectate molecule (Kohn and Luknar, 1974). Pectates with a degree of polymerization of 7 and greater are known to tightly bind calcium ion. In addition, the lower the DM of the pectate the tighter the binding of the calcium. Thus sequestration of the calcium ion necessitates the presence of a competing compound during the deesterification, whose affinity for calcium ion is greater than that of the pectate molecule itself. For example, some calcium phosphate compounds have solubility products greater than 2.5×10⁻³⁰ M at 37° C. This indicates that compounds which contain phosphate groups would act as sequestering agents for indigenous calcium ion during the deesterification of pectins in plant tissue. This process is not limited to the use of phosphates, but phosphates are the preferred compounds due to their low solubility product with calcium ion under alkaline conditions.

A separate key aspect of this process is the ability to control the relative solubility of calcium phosphates (or other calcium chelating salts) via change of pH at later stages of the process. For example, the chemical composition of many calcium orthophosphates includes hydrogen, either as an acidic orthophosphate anion such as HPO₄²⁻ or H₂PO₄⁻, and/or incorporated water as in dicalcium phosphate dihydrate (CaHPO₄.2H₂O). Most calcium orthophosphates are sparingly soluble in water but become partially soluble in acids; the calcium to phosphate molar ratios (Ca/P) and the solubilities are important parameters to distinguish between the phases (see Table 1 of Wang, L., and G. H. Nancollas, Chemical Reviews, 108(11): 4628-4669 (2008)). In general, the lower the Ca/P ratio the more acidic and soluble the calcium phosphate phase. Note that at least two hydrogen forms of calcium phosphate, brushite and monetite, have slight solubility in water and these are expected to be the dominant forms present at pH values less than 6 in water. For pH values higher than 7 the other forms of phosphate most likely exist and hence under high pH conditions calcium ions are completely sequestered by phosphate and thus are essentially insoluble in water. Thus for extractions of pectin involving high pH in the presence of phosphates, the calcium ions become tightly bound to the phosphate which is a key element in this process and virtually no calcium is available to inhibit the solubilization of pectates during extraction.

Using calcium sequestering salts is important to maintain pectate in a state wherein it can be easily dissolved by water for use in a final application by simple addition of acid to initiate release of calcium ion from calcium phosphate. Calcium pectates are insoluble in water even at temperatures greater than 80° C. under alkaline conditions, and formation of calcium pectates must be avoided until gelation or increased viscosity is required. Traditionally calcium ions are removed by the use of acid washes and filtration, which is cost ineffective and requires sophisticated processing and filtering equipment. In an embodiment describe herein, acid washing and filtering is totally avoided, resulting in cost effective and simple processes that only require screw feeders and reaction tanks. This process, for example, can utilize most of the equipment found in a citrus processing plant for production of animal feed from citrus peel waste material which saves on capitol costs for plant conversion.

Another key element of the process is the ability to do a controlled release of calcium ion via addition of acid during its use in a final application. At pH values less than 6 the solubility of calcium ion, for example brushite at 1.87×10⁻⁷ M (Wang and Nancollas 2008), is sufficient such that calcium is slowly and uniformly released and becomes bound to pectates to form shear thinning gels of calcium pectate. Shear thinning gels are necessary for applications involving suspension of particles (e.g., clays) in many industrial applications.

In an alternative embodiment to that noted in stage 2 of this process, β elimination is minimized, but in this process step the pectate molecular weight is reduced using enzymes such as pectate lyase or polygalacturonase. Pectate lyase and polygalacturonase hydrolyze the glycosidic linkages in pectates (polygalacturonic acid) thereby reducing molecular weight. Molecular weight in an embodiment with hydrolyzing enzymes is controlled via temperature, time of reaction, pH, and the number of units of enzyme (e.g., pectate lyase) added during the reaction to reduce pectate molecular weight.

Drying and milling is an optional step. As noted previously, citrus juice processing to produce waste peel that contains pectin may be a feed stock for the process described herein, but the process is not limited to citrus byproducts. Other plant tissue byproducts, such as sugar beet waste, may be acceptable sources for production of pectates for various applications. Using citrus juicing plants as an example, animal feed plants found at citrus processing plants typically use dryers (e.g., drum dryers) to remove moisture from the final product. These dryers will also be useful for removing moisture from pectates made from peel. It is feasible that the dryers will have to be de-rated which involves operating the dryers at lower temperatures in order to minimize possible charring of the final product. Despite potential de-rating of some equipment, the ability to utilize most of the equipment found in the animal feed portion of the juicing plant is an important element to minimize the capitol costs associated with pectate production. Subsequent milling (either wet or dry) may also be utilized to enhance the ability to rehydrate the product at the final application site.

Eluate from step 1 may be fermented for ethanol production. Another advantage of this processing is that the water wash from stage 2 can also be utilized to make ethanol. A method similar to that described in U.S. Pat. No. 8,372,614 may be utilized. U.S. Pat. No. 8,372,614 relates to citrus waste processing and, more particularly, a method for the conversion of simple and complex carbohydrates contained in solid citrus waste into ethanol for use as bio-fuel and to yield other high-value byproducts. The advantage of using the liquid wash obtained from step 1 as feed for ethanol production is that this minimizes the solid waste that results from art described in U.S. Pat. No. 8,372,614. In a separate embodiment, the liquid waste from step 1 could be concentrated to a higher solids content, for example using a vacuum evaporator or reverse osmosis, and the resulting syrup (containing low molecular weight sugars) could be sent to a distillery that uses syrups to make ethanol. Utilization of the liquid wash from stage 1 would result in a process which converts plant tissue byproducts into useful materials with little or no process waste products from the total process.

Unless defined otherwise, all technical and scientific terms used herein have the same meaning as commonly understood by one of ordinary skill in the art to which the invention belongs. As used herein, the term “about” refers to a quantity, level, value or amount that varies by as much as 30%, preferably by as much as 20%, and more preferably by as much as 10% to a reference quantity, level, value or amount. Although any methods and materials similar or equivalent to those described herein can be used in the practice or testing of the present invention, the preferred methods and materials are now described.

The following examples are intended only to further illustrate the invention and are not intended to limit the scope of the invention as defined by the claims.

### EXAMPLES

### Example 1

Citrus peel flour was prepared for TSP treatment by collecting peel following juice extraction. Peel was dried at 70° C. in a laboratory convection oven. Dried peel was milled in a Wiley rotary mill using a 40 mesh screen to reduce particle size to approximately 200×200 microns. To determine preferred TSP saponification conditions, four batches of 1.5% (w/v) dried peel flour were made to a slurry in cold (4° C.) 50 mM TSP (250 mL). The pH of each slurry was checked to insure it was greater than or equal to pH 11.5. The slurries were stirred in the cold (2° to 4° C.) for 24 h and the pH was checked periodically and adjusted if needed to keep it above pH 11.5. After 24 h each slurry was rapidly heated to 80° C. (approximately 3.5 min with occasional stirring) in a microwave oven. The slurries were then placed in an 80° C. oven and stirred for 15 min. Following this thermal treatment the slurries were treated as follows: (A) Treatment A: The slurry was neutralized to approximately pH 7.0 with 1 M phosphoric acid and then placed back in the 80° C. oven with stirring for an additional 15 min. (B) Treatment B: The slurry was neutralized to approximately pH 7.0 with 1 M phosphoric acid and then allowed to cool to room temperature. (C) Treatment C: The slurry was not neutralized or removed from the oven and was heated with stirring for an additional 15 min. (D) Treatment D: The slurry was not neutralized to approximately pH 7.0 with 1 M phosphoric acid and then allowed to cool to room temperature. Subsequently all samples were oven dried at 70° C. and then milled as described above.

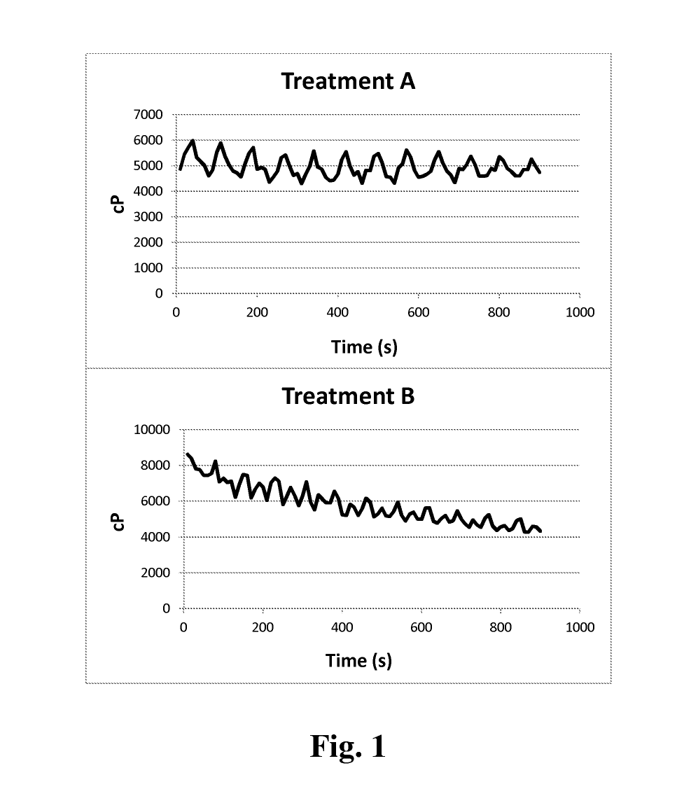

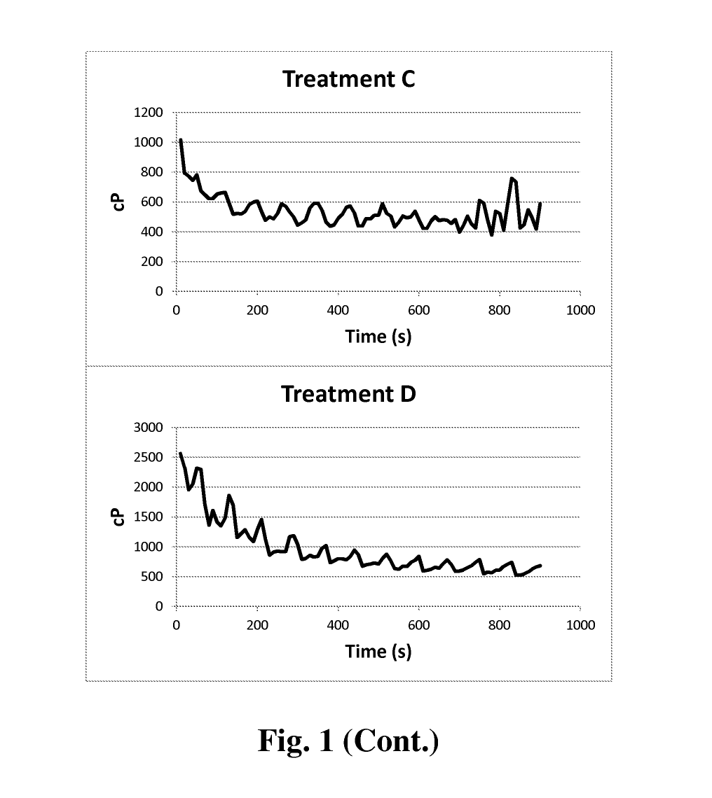

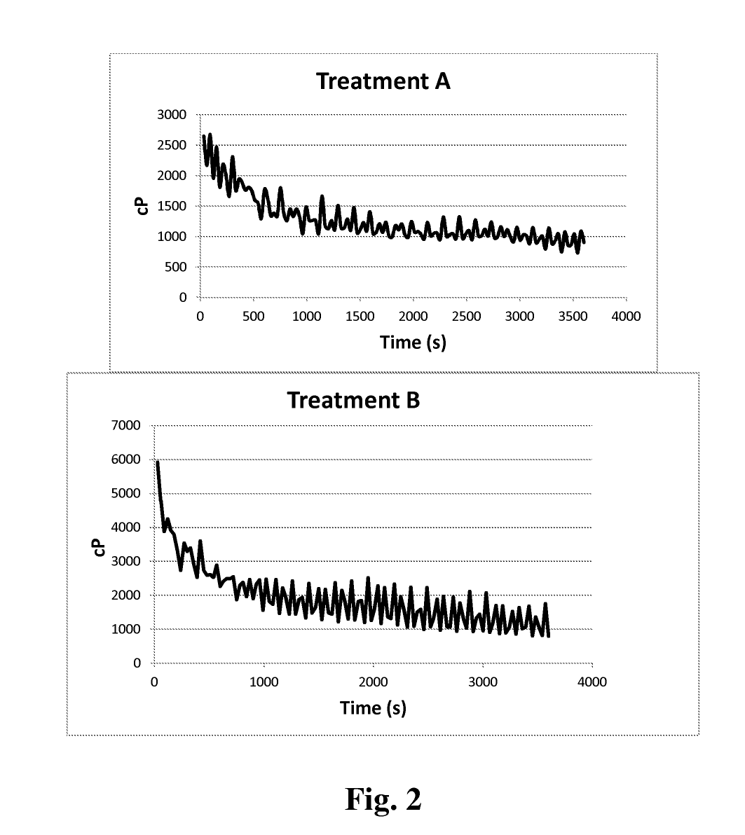

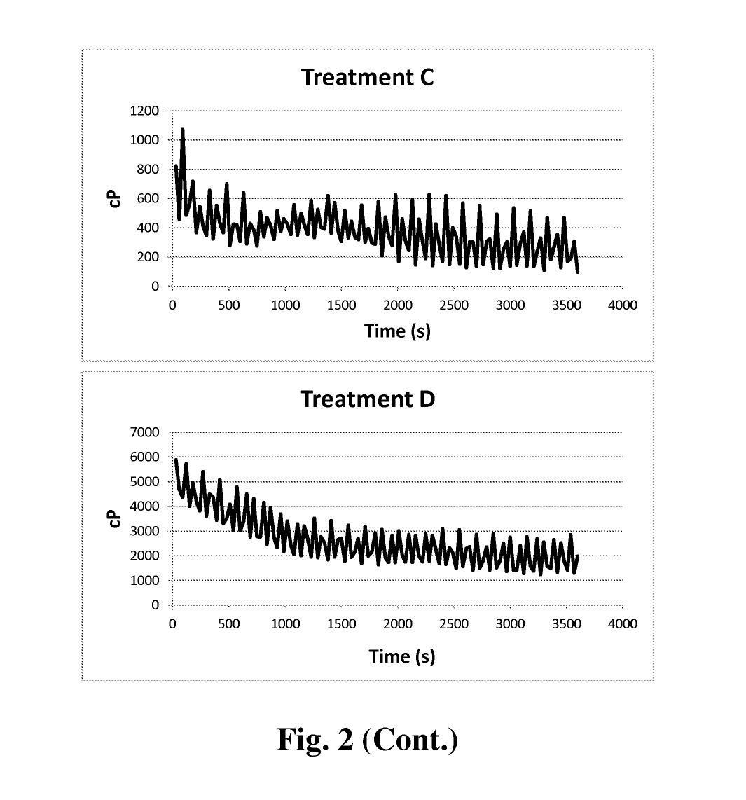

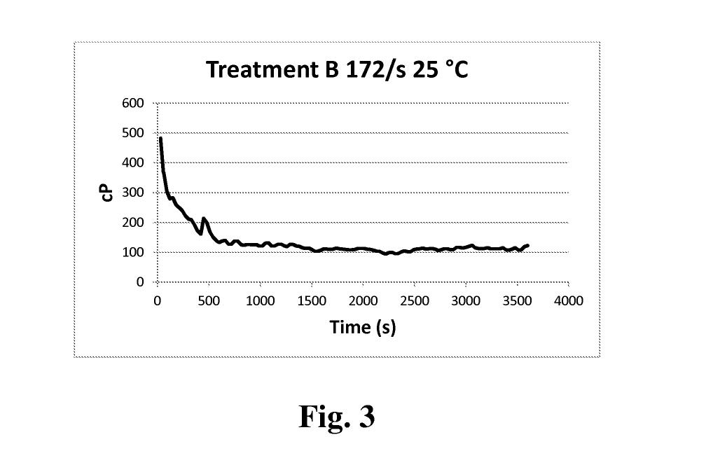

Rheological properties of these samples were characterized by oscillatory measurements using a stress controlled AR 2000 Rheometer (TA Analytical, Wilmington, Del.) equipped with 60 mm cone and plate geometry. A suspension containing 1.5% peel flour was made in deionized water and stirred vigorously for 30 min. Then 50 μL of 5 M CaCl₂ was added to 5 mL of the peel flour suspension and the mixture was placed on the geometry. Viscosity of these suspensions (as centipoise; cP) was determined at a shear rate of 20 reciprocal seconds and 25° C. over a 15 min period. Results are presented in FIG. 1. Subsequently the viscosity of Treatment B was measured at a shear rate of 172 reciprocal seconds and a temperature of 25° C. over a 60 min period (FIG. 2). Treatment C (FIG. 3) was used to measure the effects of the increased shear rate (172 reciprocal seconds) and increased temperature (65° C.) over a 60 min period.

### Example 2

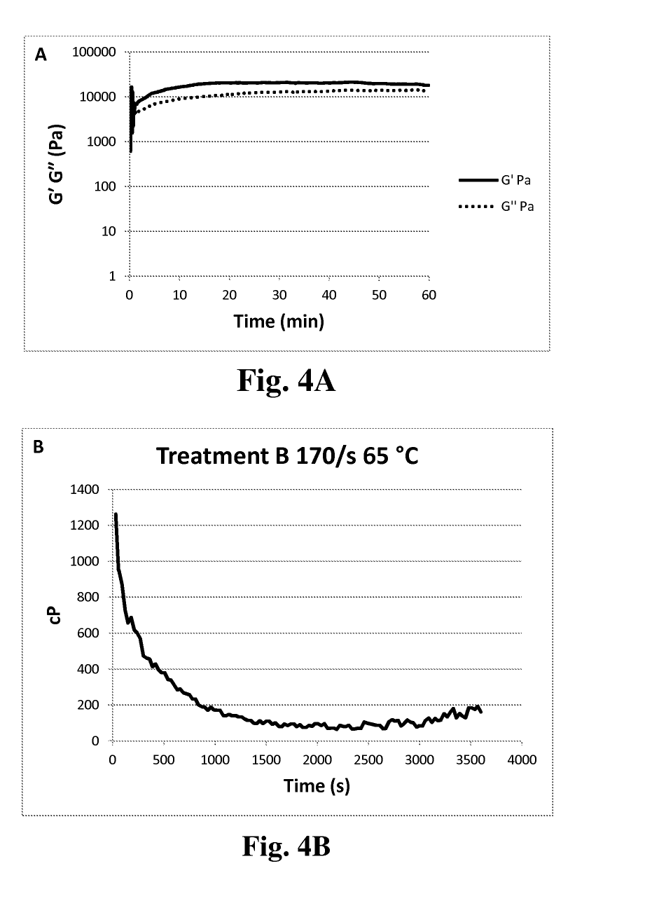

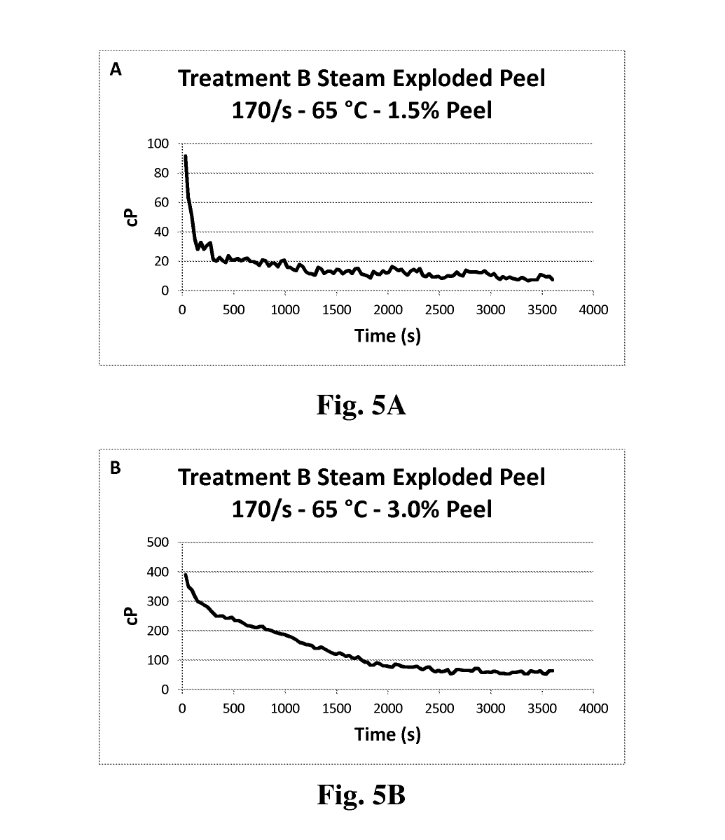

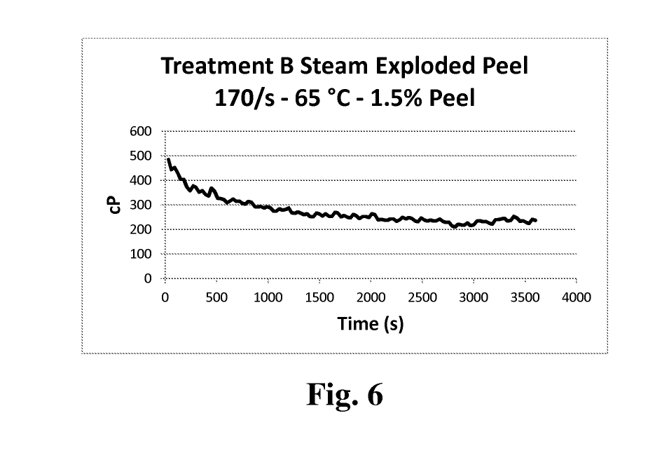

Citrus peel flour was also prepared by an alternative process in a pilot scale setting utilizing a continuous feed operation to pass citrus peel through a jet cooker in which steam was injected, raising the temperature to approximately 255° C. (post hold tube) and 40 to 50 psi at steam injection. This steam exploded citrus peel was held at this temperature for 1 to 2 minutes before the pressure was released by venting to a flash tank (the following U.S. patents are related to this methodology: U.S. Pat. Nos. 8,372,614; 7,721,980; 7,879,379) This steam exploded peel was collected and frozen at −20° C. Aliquots of this frozen material were thawed and treated with TSP as detailed for Treatment B above. Viscosity measurements were also determined as described above at 170 reciprocal seconds, 65° C. and 60 min for both 1.5% (FIGS. 4 and 6) and 3.0% (FIG. 5) suspensions.

All material prepared by the four treatments outlined in Example 1 demonstrated the ability to introduce functionality into citrus fruit peel material via TSP treatment with the addition of calcium (FIG. 1) as indicated by the measured viscosity observed at a shear rate of 20 reciprocal seconds and 25° C. A comparison of treatments demonstrated that significant improvements in viscosity were provided by neutralizing the treated peel to neutral pH (Treatments A and B). While the highest recorded viscosity was observed with Treatment B (15 minutes at 80° C.), the most stable viscosity was observed in Treatment A (total of 30 minutes at 80° C.). Testing these same hydrated samples following a 24 hour holding period demonstrated that Treatments A and B were able to maintain their functional properties at relatively high levels. Treatment D showed an increased viscosity and Treatment C had reduced viscosity.

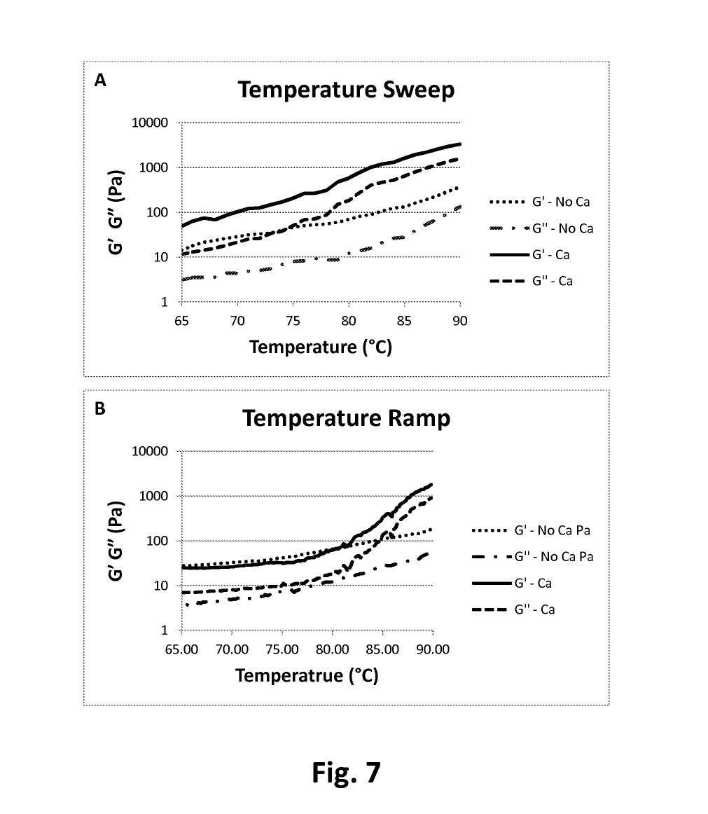

Material prepared by the methods outlined for Treatment B was used to test the effect of higher shear rates (172 or 170 reciprocal seconds) more typically encountered during materials testing for the measurement of viscous properties of completion fluids for the drilling industry (API Publishing Services, Recommended Practice for the Measurement of Viscous Properties of Completion Fluids, ISO 13503-1:2003, Washington, D.C. (2010). At the increased shear rate of 172 reciprocal seconds and 25° C., TSP treated peel was able to maintain a viscosity (100 cP over 60 minutes) within the desirable range for fracturing fluids reported by Gidley et al. (Gidley, J. L., Holditch, S. A., Neirode, D. E. and Veatch, R. W. (Eds.), Recent Advances in Hydraulic Fracturing, SPE Monograph V. 12, Society Petroleum Engineers, Richardson, Tex. (1989)). By raising the temperature to 65° C. and using a shear rate of 170 reciprocal seconds, a very strong gel could be formed as evidenced by the high G′ and G″ values which measure the viscoelastic properties of gels (FIG. 4A). The viscosity was also maintained within the desirable range with a minimum of approximately 100 cP (FIG. 4B). Trials using material produced as described in Example 2 where steam explosion was used to release pectic fragments also demonstrated functionalization of the treated material. Some variability was observed depending on the source of peel or perhaps run to run variation in temperature and pressure. FIGS. 5 and 6 represent functionalized peel material from two separate runs and show run dependent differences in viscosity. At a concentration of 1.5% the TSP treated material produced low viscosity measurements (FIG. 5A) while the peel from a second source (FIG. 6) produced higher viscosities. The TSP treated peel material shown in FIG. 6 demonstrated cP values well above the minimums indicated by Gidley et al. (1989) or the American Petroleum Institute's standard (American Petroleum Institute 2010). In FIG. 5 we also saw a concentration effect with higher viscosity values at 3.0% than 1.5%. FIG. 7 illustrates the effect of temperature on gel strength of TSP treated peel material in the presence or absence of additional calcium (greater than naturally occurring in peel). In both the temperature sweep (constant increase in temperature; FIG. 7A) and the temperature ramp (incremental increase in temperature; FIG. 7B) the presence of additional calcium produced an order of magnitude increase in G′ and G″ values at the higher temperatures.

All of the references cited herein, including U.S. patents, are incorporated by reference in their entirety.

Thus, in view of the above, there is described (in part) the following:

A process to produce polygalacturonic acids from pectin containing products, said process comprising (or consisting essentially of or consisting of)
(a) optionally washing pectin containing products (resulting product contains solids and water),
(b) optionally injecting dry steam into pectin containing products (and maintaining a temperature of about 140° to about 160° C. (e.g., 140° to 160° C.) under pressure at about 40 to about 60 psi (e.g., 40 to 60 psi) for a time period of between about 0.5 to about 3 minutes (e.g., 0.5 to 3 minutes)),
(c) optionally heating to above about 70° C. to about 95° C. or optionally cooling to less than about 10° C. (generally above 0° C. to avoid freezing),
(d) adding to said pectin containing products at least one calcium sequestering salt (either in dry form or as a solution) in an amount sufficient to provide a mixture having a pH of equal to or greater than about 8 (from about 8 to about 14 (e.g., 8 to 14), more preferably from about 8 to about 12 (e.g., 8 to 12), and most preferably from about 9 to about 11 (e.g., 9 to 11)) and a total molarity of phosphate greater than a total molarity of Ca⁺⁺ indigenous to said pectin containing products,
(e) optionally cooling or heating after adding said at least one calcium sequestering salt,
(f) storing the mixture of pectin containing products and at least one calcium sequestering salt for about 24 hours or less (following cooling and then blending the mixture is stored for a sufficient time to reduce ester content of 0% to about 20% (e.g., 0 to 20%), preferably below about 20% (e.g., below 20%); preferred time of storage is less than about 24 hours (e.g., less than 24 hours), more preferably less than about 12 hours (e.g., less than 12 hours), more preferably about 2 to about 8 hours (e.g., 2 to 8 hours), and most preferably less than about 8 hours (e.g., less than 8 hours, with lower limit of about 1 hour with addition of excess phosphate),
(g) heating said mixture for about 15 min to about 4 hours at about 40° to about 95° C. (from about 40° to about 95° C. (e.g., 40° to 95° C.), more preferably from about 60° to about 90° C. (e.g., 60° to 90° C.), and most preferably from about 75° to about 85° C. (e.g., 75° to 85° C.), is done from about 15 minutes to about 4 hours (e.g., 15 minutes to 4 hours), preferably from about 15 minutes to 2 hours (e.g., 15 minutes to 2 hours), more preferably from about 15 to about 60 minutes (e.g., 15 to 60 minutes), and most preferably from about 15 to about 30 minutes (e.g., 15 to 30 minutes) to form insoluble calcium phosphates and to extract pectates formed in-situ from the pectin-containing plant material. Separation of the unbound pectates from other materials present in the mixture is not required (and is generally not done) prior to drying which saves on processing cost and aids in product stability; pectates are extracted (no longer covalently bound) but are not separated from the mixture, they remain part of the mixture),
(h) optionally adjusting the pH of said mixture to about 7 to about 8 by adding acid to said mixture (neutralization of the blend, by addition of acid (e.g., nitric acid, phosphoric acid, hydrochloric acid), prior to drying to a pH between the values of about 7 to about 8 (e.g., 7 to 8) is optional to lower the alkalinity of the blend; the unbound pectate preferably has a degree of esterification (DE) of less than about 10% (e.g., less than 10%) and a high degree of polymerization (for high gel strength applications); the degree of polymerization being characterized by a molecular size of greater than about 17,500 Daltons (e.g., greater than 17,500 Daltons), preferably greater than about 30,000 (e.g., greater than 30,000 Daltons), more preferably >about 70,000 Daltons (e.g., greater than 70,000 Daltons), and most preferably >about 120,000 Daltons (e.g., greater than 120,000 Daltons) on average which is the typical upper limit for unaggregated pectins which are extracted from citrus peel, but may be higher if other plant tissue sources are utilized),
(i) optionally drying said mixture which contains polygalacturonic acids, and
(j) optionally milling or grinding said mixture.

The above process, wherein said polygalacturonic acids have a degree of esterification of less than about 50% [(e.g., less than 50%), more preferably less than 20% (e.g., less than 20%), preferably 0% to about 10% (e.g., 0% to 10%), and most preferably less than 10% (e.g., less than 10%)) esterified pectins (also known as pectates)].

The above process, wherein said polygalacturonic acids have a degree of polymerization >than about 20 galacturonic acid units on average (e.g., greater than 20), preferably >than about 150 (e.g., greater than 150), more preferably >than 300 (e.g., greater than 300), and most preferably >than 600 (e.g., greater than 600) galacturonic acid units on average).

The above process according to claim 1, wherein said polygalacturonic acids have a degree of polymerization <about 600 galacturonic acid units on average (e.g., less than 600), more preferably <200 (e.g., less than 200), more preferably one to about 20 (e.g., one to 20), and most preferably <about 20 (e.g., less than 20) galacturonic acid units on average).

The above process, wherein said calcium sequestering salt is selected from the group consisting of monovalent cations of sodium, potassium, ammonium, and mixtures thereof.

The above process, wherein said calcium sequestering salt is selected from the group consisting of phosphate compounds such as trisodium phosphate, tripotassium phosphate, triammonium phosphate, and mixtures thereof.

The above process, wherein said process does not utilize heavy metal ions (e.g., borate).

Polygalacturonic acids produced by the above process.

A gel comprising (or consisting essentially of or consisting of) the polygalacturonic acids produced by the above process and water (gels exhibit substantially no phase separation in an aqueous solution and thus can maintain suspension properties).

The above gel, further comprising an acid.

The above gel, further comprising polyvalent cations (e.g., calcium ions (calcium chloride, calcium nitrate, calcium sulfate) or monovalent cations.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

TABLE 1
Ca/P Molar Ratios, Formulas, and Solubilities* of Some Calcium Orthophosphate Minerals

| Ca/P mole | | | solubility | solubility | solubility |
|---|---|---|---|---|---|
| ratio | compound | formula | 25° C., −log(Kₛₚ) | 37° C., −log(Kₛₚ) | product 37° C. |
| 1.00 | brushite (DCPD) | CaHPO₄•2H₂O | 6.59 | 6.73 | 1.87 × 10⁻⁷ M |
| 1.00 | monetite (DCPA) | CaHPO₄ | 6.90 | 6.04 | 9.2 × 10⁻⁷ M |
| 1.33 | octacalcium | Ca₈(HPO₄)₂(PO₄)₄•5H₂O | 96.6 | 98.6 | 2.5 × 10⁻⁹⁹ M |
| | phosphate (OCP) | | | | |
| 1.20-2.20 | amorphous calcium | CaₓH_{y}(PO₄)_{z}•nH₂O, | ~ | ~ | |
| | phosphate (ACP) | n = 3-4.5; 15-20% H₂O | | | |
| 1.50 | α-tricalcium | α-Ca₃(PO₄)₂ | 25.5 | 28.5 | 2.8 × 10⁻²⁹ M |
| | phosphate (α-TCP) | | | | |
| 1.50 | β-tricalcium | β-Ca₃(PO₄)₂ | 28.9 | 29.6 | 2.5 × 10⁻³⁰ M |
| | phosphate (β-TCP) | | | | |
| 1.67 | hydroxyapatite | Ca₁₀(PO₄)₆(OH)₂ | 116.8 | 117.2 | 5.5 × 10⁻¹¹⁸ M |
| | (HAP) | | | | |
| 1.67 | fluorapatite (FAP) | Ca₁₀(PO₄)₆F₂ | 120.0 | 122.3 | 5.0 × 10⁻¹²³ M |

*The solubility is given as the logarithm of the ion product of the given formulas (excluding hydrate water) with concentrations in mol/L (M).
(~ cannot be measured precisely.)
(Table taken from Wang & Nancollas (Wang, L., and G. H. Nancollas, Chemical Reviews, 108(11): 4628-4669 (2008).

We claim:

1. A process to produce polygalacturonic acids from pectin containing products, said process comprising
(a) optionally washing pectin containing products,
(b) optionally injecting dry steam into pectin containing products [and maintaining a temperature of about 140° to about 160° C. under pressure at about 40 to about 60 psi for a time period of between about 0.5 to about 3 minutes,
(c) optionally heating pectin containing products to above about 70° C. to about 95° C. or optionally cooling to less than about 10° C.,
(d) adding to said pectin containing products at least one calcium sequestering salt in an amount sufficient to provide a mixture having a pH of equal to or greater than about 8 and a total molarity of phosphate greater than a total molarity of Ca⁺⁺ indigenous to said pectin containing products,
(e) optionally cooling or heating after adding said at least one calcium sequestering salt,
(f) storing the mixture of pectin containing products and at least one calcium sequestering salt for about 24 hours or less,
(g) heating said mixture for about 15 min to about 4 hours at about 40° to about 95° C.,
(h) optionally adjusting the pH of said mixture to about 7 to about 8 by adding acid to said mixture,
(i) optionally drying said mixture which contains polygalacturonic acids, and
(j) optionally milling or grinding said mixture.

2. The process according to claim 1, wherein said polygalacturonic acids have a degree of esterification of less than about 50%.

3. The process according to claim 1, wherein said polygalacturonic acids have a degree of polymerization >than about 20 galacturonic acid units on average.

4. The process according to claim 1, wherein said polygalacturonic acids have a degree of polymerization <about 600 galacturonic acid units on average.

5. The process according to claim 1, wherein said calcium sequestering salt is selected from the group consisting of monovalent cations of sodium, potassium, ammonium, and mixtures thereof.

6. The process according to claim 1, wherein said calcium sequestering salt is selected from the group consisting of phosphate compounds such as trisodium phosphate, tripotassium phosphate, triammonium phosphate, and mixtures thereof.

7. Polygalacturonic acids produced by the process according to claim 1.

8. A gel comprising the polygalacturonic acids produced by the process according to claim 1 and water.

9. The gel according to claim 8 further comprising an acid.

10. The gel according to claim 8, further comprising polyvalent cations or monovalent cations.
